(19) United States
(12) Patent Application Publication
(10) Pub. No.: US 2025/0246619 A1
(43) Pub. Date: Jul. 31, 2025

(54) NON-AQUEOUS SECONDARY BATTERY AND MANUFACTURING METHOD OF NON-AQUEOUS SECONDARY BATTERY

(71) Applicant: TOYOTA JIDOSHA KABUSHIKI KAISHA, Toyota-shi (JP)

(72) Inventor: Yusuke MORIKAWA, Toyota-shi (JP)

(73) Assignee: TOYOTA JIDOSHA KABUSHIKI KAISHA, Toyota-shi (JP)

(21) Appl. No.: 18/947,165

(22) Filed: Nov. 14, 2024

(30) Foreign Application Priority Data
Jan. 31, 2024 (JP) 2024-012896

(51) Int. Cl. H01M 4/525; H01M 4/02; H01M 4/1391; H01M 4/62; H01M 10/0568; H01M 10/058

(52) U.S. Cl. CPC H01M 4/525; H01M 4/1391; H01M 4/623; H01M 4/625; H01M 10/0568; H01M 10/058; H01M 2004/028

(57) ABSTRACT

A non-aqueous secondary battery comprising a cathode and a anode and a non-aqueous electrolyte, wherein the non-aqueous electrolyte contains at least one of calcium ions and magnesium ions at a 0.1 mol/L or higher concentration with the entire non-aqueous electrolyte solution as a standard, and the cathode includes a non-aqueous secondary battery containing dehydroascorbic acid, a cathode active material, a salt containing calcium ions or magnesium ions, and a cathode composite material mixed with ascorbic acid, a step of forming a battery comprising a cathode, a anode, and a non-aqueous electrolyte, and a step of decomposing the salt by applying a voltage to the battery, wherein the cathode composite material includes a non-aqueous secondary battery containing the salt as a standard and 1% by mass or more of the total cathode composite material.

### CROSS-REFERENCE TO RELATED APPLICATION

This application claims priority to Japanese Patent Application No. 2024-012896 filed on Jan. 31, 2024, incorporated herein by reference in its entirety.

### BACKGROUND

### 1. Technical Field

The present disclosure relates to a non-aqueous secondary battery and a manufacturing method of the non-aqueous secondary battery.

### 2. Description of Related Art

There is known a non-aqueous secondary battery in which a cathode includes a phosphate represented by LivT^{a}PO₄ (0≤v≤1, where Ta is Fe, Ni, Co, Mn, etc.) of an olivine structure as cathode active material, and contains lithium oxalate as a sacrificial salt (Japanese Unexamined Patent Application Publication (Translation of PCT Application) No. 2018-526788 (JP 2018-526788 A)). With respect to this non-aqueous secondary battery, a method of forming a battery cell is known in which a cell is heated to 30° C. to 45° C. and then charged at a particular voltage (JP 2018-526788 A). JP 2018-526788A describes that lithium ions are released into an electrolyte by lithium oxalate, which is a sacrificial salt, and there is no need to charge the cell with extra amounts of cathodes to form a solid-electrolyte interphase (SEI). JP 2018-526788 A also describes that energy density of the battery is improved.

Also, an electrolyte in which magnesium ions and aluminum ions are dissolved in an ether-based organic solvent is known (Japanese Unexamined Patent Application Publication No. 2009-064730 (JP 2009-064730 A)). In this electrolyte, there is known an electrolyte in which metal magnesium, halogenated hydrocarbon, aluminum halide, and quaternary ammonium salt are added to an ether-based organic solvent (JP 2009-064730 A).

### SUMMARY

In non-aqueous secondary batteries, sacrificial salts, such as lithium oxalate, Li₂C₄O₆, and so forth, required the batteries to be charged to relatively high voltages such as 4.7 V to 4.8 V for example, for decomposition thereof. It is conceivable that such high voltages cause a high-potential state, generation of singlet oxygen, and so forth, which in turn cause formation of an excess film on active material. There is concern that this excess film may generate gas, and also there is a possibility that improvement in energy density will be limited.

Further, the electrolyte in which the magnesium ions are dissolved is suitable for magnesium ion batteries.

A problem to be solved by embodiments of the present disclosure is to provide a non-aqueous secondary battery and a manufacturing method of the non-aqueous secondary battery, in which energy density is improved, while suppressing generation of gas.

Means for solving the problem include the following aspects.
1
   A non-aqueous secondary battery includes a cathode, an anode, and a non-aqueous electrolyte, in which
the non-aqueous electrolyte contains at least one of calcium ions and magnesium ions at a concentration of 0.1 mol/L or higher, with respect to the entire non-aqueous electrolyte, and
the cathode contains dehydroascorbic acid.
2
   In the non-aqueous secondary battery according to 1,
the non-aqueous electrolyte contains calcium ions, and
reactive potential of anode material included in the anode is 0.26 V vs. Li/Li⁺ or higher.
3
   In the non-aqueous secondary battery according to 1,
the non-aqueous electrolyte contains magnesium ions, and
reactive potential of anode material included in the anode is 0.74 V vs. Li/Li⁺ or higher.
4
   In the non-aqueous secondary battery according to any one of 1 to 3,
the cathode includes at least one salt selected from a group consisting of magnesium oxide, calcium oxide, and magnesium carbonate, and ascorbic acid,
at least a portion of each of the calcium ions and the magnesium ions is derived from a salt included in the cathode, and
the dehydroascorbic acid is derived from ascorbic acid included in the cathode.
5
   A manufacturing method of a non-aqueous secondary battery includes
producing a cathode using a cathode composite material in which a cathode active material,
a salt containing calcium ions or magnesium ions, and ascorbic acid are mixed,
fashioning a battery including the cathode, an anode, and a non-aqueous electrolyte, and
applying a voltage to the battery to decompose the salt, in which
the cathode composite material contains the salt in an amount of 1% by mass or more with respect to the entire cathode composite material.

According to the present disclosure, there is provided a non-aqueous secondary battery and a manufacturing method of the non-aqueous secondary battery, in which energy density is improved, while suppressing generation of gas.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram illustrating a material included in a cathode and an electrolyte before and after a preliminary charge.

### DETAILED DESCRIPTION OF EMBODIMENTS

Hereinafter, embodiments of the present disclosure will be described with reference to the drawings.

When an embodiment of the present disclosure is described with reference to the drawings, the configuration of the embodiment is not limited to the configuration shown in the drawings. Components denoted by the same reference numerals in the drawings mean the same components. In the drawings, only some of the components may be labeled. The proportions of dimensions in the drawings do not necessarily represent the proportions of actual dimensions.

In the present disclosure, numerical ranges specified herein with “A-B,” “between A and B,” “(from) A to B,” etc., represent ranges, which include the minimum A and the maximum B.

In the numerical range described in the present disclosure in a stepwise manner, the upper limit value or the lower limit value described in a certain numerical range may be replaced with the upper limit value or the lower limit value of the numerical range described in another stepwise manner. In the numerical ranges described in the present disclosure, the upper limit value or the lower limit value described in a certain numerical range may be replaced with the value shown in the examples.

In the present disclosure, the term “step” is included in the term as long as the intended purpose of the step is achieved, even if it is not clearly distinguishable from other steps as well as independent steps.

In the present disclosure, a combination of two or more preferred embodiments is a more preferred embodiment.

In the present disclosure, the amount of each component means the total amount of a plurality of substances unless otherwise specified, when a plurality of substances corresponding to each component are present.

### Non-Aqueous Secondary Battery

The non-aqueous secondary battery of the present disclosure is a non-aqueous secondary battery (hereinafter, also referred to as a battery) including a cathode, a anode, and a non-aqueous electrolyte (hereinafter, also referred to as an electrolyte). In this non-aqueous secondary battery, the electrolyte contains at least one of calcium ions and magnesium ions at a 0.1 mol/L or higher based on the entire electrolyte, and the cathode contains dehydroascorbic acid.

### Cathode

The cathode is a cathode used in a non-aqueous secondary battery, and includes, for example, a current collector and a cathode layer disposed on a surface of the current collector. The cathode layer may be disposed on one side or both sides of the current collector. The cathode layer can be formed using a cathode composite material.

Examples of the material constituting the current collector of the cathode include aluminum, an aluminum alloy, nickel, titanium, and stainless steel. Examples of the shape of the current collector include a foil and a mesh.

The cathode composite material includes a cathode active material, a salt, ascorbic acid, and other materials. Other materials include a conductive material, a binder, an electrolytic solution, and the like. As the cathode active material, a conventionally known cathode active material according to the type of battery can be used. For example, in the case of a lithium-ion battery, a lithium transition metal oxide, a lithium transition metal phosphate compound (e.g., LiFePO₄), or the like can be used. The lithium transition metal oxide is, for example, LiNi_{0.8}Co_{0.1}Mn_{0.1}O₂, LiNi_{1/3}Co_{1/3}Mn_{1/3}O₂, LiNiO₂, LiCoO₂, LiFeO₂, LiMn₂O₄, LiNi_{0.5}Mn_{1.5}O₄.

The non-aqueous secondary battery of the present disclosure can be widely applied not only to a lithium-ion battery but also to a sodium-ion battery, a potassium-ion battery, or the like as long as it is a non-aqueous secondary battery. In the present disclosure, a case of a lithium ion battery will be described as an example.

In the non-aqueous secondary battery, when an initial voltage is applied, the salt contained in the cathode composite material decomposes, and at least one of calcium ions and magnesium ions is released into the electrolytic solution. At least a part of each of the calcium ion and the magnesium ion is derived from a salt included in the cathode. Hereinafter, such a salt is also referred to as “sacrificial salt”.

The sacrificial salt included in the cathode composite material is preferably a sacrificial salt that generates at least one of calcium ions and magnesium ions by applying a voltage such as preliminary charging. Calcium ions or magnesium ions are cations generated by the decomposition of the sacrificial salt. The sacrificial salt may comprise one or more.

As the sacrificial salt, a salt of an alkaline earth metal may be used. That is, the sacrificial salt may be a sacrificial salt that releases alkaline earth metal cations by decomposition. The sacrificial salt is preferably selected based on the released cationic valence per unit volume of sacrificial salt and the theoretical decomposition potential. More preferably, the sacrificial salt is selected based on the effective released cation amount and theoretical decomposition potential per unit volume of sacrificial salt and the effective released cation amount of the cathode active material. Specific examples of the sacrificial salt preferably include magnesium oxide (MgO), calcium oxide (CaO), magnesium carbonate (MgCO₃), and lithium carbonate (Li₂CO₃). Specific examples of the sacrificial salt preferably include sodium carbonate (Na₂CO₃), lithium peroxide (Li₂O₂), and lithium oxalate (Li₂C₂O₄). Among them, the sacrificial salt is preferably at least one salt selected from the group consisting of MgO, CaO, and MgCO₃ in terms of low theoretical decomposition potential and high effective release cationic content.

Each of the above-mentioned sacrificial salts can increase the effective

emission cation amount of each sacrificial salt more than the effective emission cation amount of the cathode active material based on the effective emission cation amount per unit volume of each sacrificial salt, thereby improving the energy density of the battery. Note that the effective emission cation amount is not the number of ions to be emitted, but is the amount of electrons contributing to the reaction when converted into an amount assuming that all monovalent ions have been emitted.

Furthermore, since the sacrificial salt mentioned above is found to be decomposed at a relatively low potential based on the theoretical decomposition potential of each sacrificial salt, generation of active oxygen can be suppressed.

Specifically, the effective release cations per unit volume [mm o 1/cm³] in the above-mentioned sacrificial salts have a MgO of 178 [mm o 1/cm³], a CaO of 119 [mm o 1/cm³], and a MgCO₃ of 70 [mm o 1 /cm^{3]}. For example, when the cathode active material is LiNi_{0.8}CO_{0.1}Mn_{0.1}O₂, the effective release cations per unit volume is 37 [mm o 1/cm³]. Therefore, each of these sacrificial salts has an effective emission cation amount greater than that of the cathode active material by 1.5 times or more. Therefore, when each of the above-mentioned sacrificial salts is used, the amount of electrons contributing to the reaction in the electrode is sufficient to increase the energy density of the battery.

Specifically, the theoretical decomposition potentials of the above-mentioned sacrificial salts are 2.9 [V vs. Li/Li⁺] in MgO, 3.1 [V vs. Li/Li⁺] in CaO, and 3.2 [V vs. Li/Li⁺] in MgCO₃. Therefore, when each of the above-mentioned sacrificial salts is used, the theoretical decomposition potential is relatively low, and formation of an extra film can be suppressed.

In the non-aqueous secondary battery, the electrolyte solution contains at least one of calcium ions and magnesium ions at a 0.1 mol/L or higher based on the entire electrolyte solution. After applying a voltage to the battery by preliminary charging or the like, the electrolytic solution contains calcium ions or magnesium ions at a concentration of 0.1 mol/L or more based on the entire electrolytic solution. Preferably, the electrolyte contains calcium ions or magnesium ions in a concentration of not less than 0.1 mol/L and not more than 0.3 mol/L based on the entire electrolyte. More preferably, the electrolyte solution contains calcium ions or magnesium ions in a concentration of not less than 0.1 mol/L and not more than 0.2 mol/L based on the entire electrolyte solution. When it is within the above range, the effect of increasing the energy density of the battery can be more reliably achieved while suppressing the formation of an extra coating film. In addition, when the amount is within the above range, there is little possibility that the function as an electrolytic solution is inhibited.

The concentration of calcium ions or magnesium ions in the electrolytic solution can be adjusted by the amount of the sacrificial salt contained in the cathode composite material or the like.

The sacrificial ion concentration, including calcium ions or magnesium ions, in the electrolyte after charge is measured by inductively coupled plasma-mass spectrometry (ICP-MS).

The electrolytic solution may include both calcium ions and magnesium ions. Here, the electrolyte solution contains calcium ions or magnesium ions at a level equal to or higher than 0.1 mol/L based on the entire electrolyte solution.

A gap formed by the sacrificial salt contained in the cathode layer before the preliminary charge is formed in the cathode layer after the preliminary charge. It is considered that this void exists in the cathode in an appropriate size, number, distribution, and the like, and contributes to improving the ion diffusibility and enhancing the rapid charging performance.

The cathode composite material preferably contains the sacrificial salt in an amount of 1.0% by mass or more and 5.0% by mass or less, and more preferably in an amount of 1.5% by mass or more and 4.0% by mass or less, based on the entire cathode composite material. When the cathode composite material contains the sacrificial salt within the above range, the effect of adding the sacrificial salt can be more reliably exhibited, the energy density of the battery can be improved, generation of an extra coating film is suppressed, and generation of gas is suppressed. Specifically, when the cathode composite material contains the sacrificial salt within the above range, the total concentration of calcium ions and magnesium ions in the electrolytic solution can be set to be equal to or higher than 0.1 mol/L based on the entire electrolytic solution.

The cathode composite material contains ascorbic acid in addition to the sacrificial salt. The sacrificial salt may be oxidatively decomposed by precharge to generate reactive oxygen, represented by singlet oxygen. It is believed that singlet oxygen reacts with a solvent or the like of the electrolyte to form an extra coating. This extra coating may consist of organic components, LiF, etc., and may lead to gassing. The ascorbic acid contained in the cathode composite material is considered to be preferentially oxidized by singlet oxygen, and the reaction between the singlet oxygen and the electrolyte solvent can be suppressed, and the formation of an extra film can be further suppressed.

At the cathode where the precharge is completed, ascorbic acid is oxidized to dehydroascorbic acid. Therefore, in the non-aqueous secondary battery of the present disclosure, the cathode contains dehydroascorbic acid. the dehydroascorbic acid is derived from ascorbic acid included in the cathode.

The cathode composite material preferably contains ascorbic acid in an amount of 1% by mass or more and 8% by mass or less, and more preferably in an amount of 2% by mass or more and 4% by mass or less, based on the entire cathode composite material. When the cathode composite material contains ascorbic acid within the above range, the effect of the addition of ascorbic acid is more reliably exhibited, generation of an extra coating film is suppressed, and generation of gas (particularly, gas during use of a battery) is also suppressed.

The generated gas includes carbon monoxide, a hydrocarbon gas such as ethane, carbon dioxide, and the like.

The cathode composite material may be a mixture containing a cathode active material, a sacrificial salt, and a component other than ascorbic acid, such as a conductive aid and a binder. If desired, a solvent may be added to the mixture to adjust the viscosity of the mixture.

Specific examples of the conductive aid include carbon materials such as carbon black (acetylene black, thermal black, furnace black, and the like), carbon nanotubes, and graphite.

The conductive auxiliary material contained in the cathode composite material may be one kind alone or two or more kinds thereof.

Specific examples of the binder include polyvinylidene fluoride (PVDF), polyethylene, polypropylene, polyethylene terephthalate, cellulose, nitrocellulose, carboxymethylcellulose, and polyethylene oxide. Specific examples of the binder include polyepichlorohydrin, polyacrylonitrile, styrene-butadiene rubber (SBR), acrylonitrile-butadiene rubber (NBR), polyacrylates, and polymethacrylates.

The binder contained in the cathode composite material may be one kind alone or two or more kinds thereof.

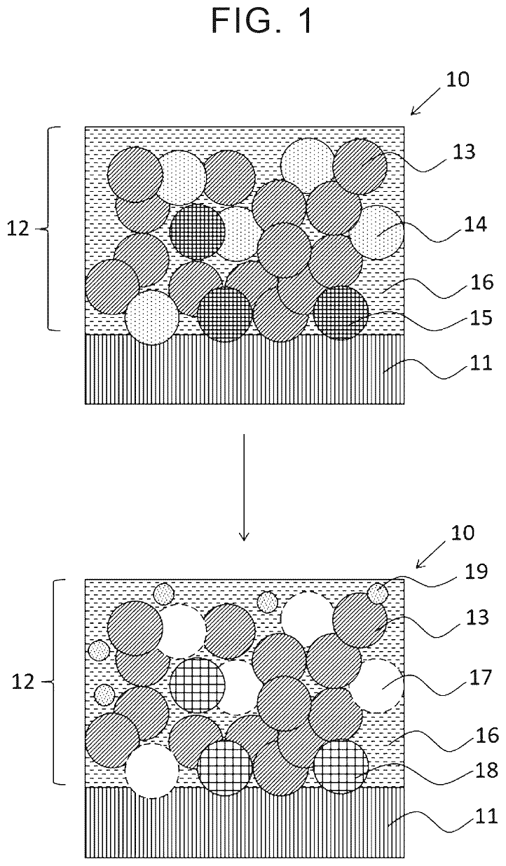

The cathode will be further described with reference to the drawings. As shown in FIG. 1, the cathode 10 is configured by disposing a cathode layer 12 formed of a cathode composite material on the surface of a current collector 11, and the cathode layer 2 contains a cathode active material 13, a sacrificial salt 14, and ascorbic acid 15 dispersed therein. The cathode 10 is adjacent to the electrolyte 16. After the battery is pre-charged, the cathode layer 12 in the cathode 10 includes the cathode active material 13, the void 17 formed due to decomposition of the sacrificial salt 14, and dehydroascorbic acid 18. The sacrificial salt 14 is decomposed to an alkaline earth metal ion 19, such as Mg²⁺ or Ca²⁺, which is present in the electrolyte 16.

In the cathode layer 12 after the precharge, there is a void 17 generated by the sacrificial salt 14. This void 17 is appropriately present in the cathode 10, and is considered to contribute to improving the diffusibility of various ions and enhancing the rapid charging performance.

### Anode

The anode includes, for example, a current collector and a anode layer disposed on the current collector and including a anode active material. Examples of the anode active material include carbon materials such as graphite, hard carbon, soft carbon, and activated carbon, silicon, metallic lithium, lithium alloy, and lithium titanate (LTO). Examples of the material constituting the current collector of the anode include copper, a copper alloy, nickel, titanium, and stainless steel. Examples of the shape of the current collector of the anode include a foil and a mesh.

For example, magnesium metal is known to be difficult to form dendrites, and there is little concern about safety even if metal is deposited. Therefore, although it is not necessary to suppress the precipitation of the metal, when it is not desired to deposit the metal on the anode, it is preferable to use a anode material in which the charge-discharge reaction proceeds at a potential higher than the precipitation dissolution reaction potential. Li₄Ti₅O₁₂, TiNb₂O₇, SiO and the like are exemplified as the anode material in which the precipitation of the metal is suppressed.

Since the precipitation-dissolution reaction potential of the calcium metal is 0.21 V vs. Li/Li⁺, when the non-aqueous electrolyte contains calcium ions, the anode material included in the anode preferably has a reaction potential of 0.26 V vs. Li/Li⁺ or more. In addition, the precipitation-dissolution potential of the magnesium-metal is 0.69 V vs. Li/Li⁺. Therefore, when the non-aqueous electrolyte contains magnesium ions, the anode material included in the anode preferably has a reactive potential of 0.74 V vs. Li/Li⁺ or higher.

### Electrolyte

The electrolyte may be either a liquid or a solid. As the liquid electrolyte (electrolyte solution), a solution obtained by dissolving a known electrolyte such as LiPF₆ in an organic solvent can be used without any particular limitation.

Specific examples of the organic solvents include cyclic or linear carbonates such as ethylene carbonate (EC), dimethyl carbonate (DMC), diethyl carbonate (DEC), and ethyl methyl carbonate (EMC). The solvent may be a mixture of two or more solvents or a mixture comprising a cyclic carbonate and a linear carbonate.
Solvents may include additives such as vinylene carbonate (VC).
As the solid electrolyte, a known solid electrolyte such as a sulfide solid electrolyte, an oxide solid electrolyte, or a halide solid electrolyte can be used without any particular limitation.

### Separator

The lithium ion secondary battery may include a separator disposed between the cathode and the anode. Examples of the separator include a nonwoven fabric, a cloth, and a microporous film containing a polyolefin as a main component, such as polyethylene and polypropylene.

### Method of Manufacturing Non-Aqueous Secondary Battery

The method for producing a non-aqueous secondary battery of the present disclosure includes a step of producing a cathode using a cathode composite material containing a cathode active material, a salt containing at least one of calcium ions and magnesium ions, and ascorbic acid. The method of manufacturing a non-aqueous secondary battery of the present disclosure further includes a step of forming a battery including a cathode, a anode, and a non-aqueous electrolyte. The method of manufacturing a non-aqueous secondary battery of the present disclosure further includes a step of decomposing the salt by applying a voltage to the battery. the cathode composite material contains the salt in an amount of 1% by mass or more with respect to the entire cathode composite material.

### Cathode Production Process

The method for producing a non-aqueous secondary battery of the present disclosure includes a step of producing a cathode using a cathode composite material containing a cathode active material, a salt containing at least one of calcium ions and magnesium ions, and ascorbic acid. As the salt used in the cathode composite material, the sacrificial salt described above is used, and plays a function of releasing at least one of calcium ions and magnesium ions by decomposition upon application of a voltage. The ratio of the salt contained in the cathode composite material and the ratio of the ascorbic acid are as described in <non-aqueous Secondary Battery>, respectively.

As a method of forming the cathode composite material, a conventionally known method can be employed. For example, the material forming the cathode composite material is mixed to form the cathode composite material. As a method of forming the cathode, for example, a cathode composite material is applied to the surface of the current collector, and a cathode layer is disposed on the surface of the current collector. The arrangement is performed, for example, by coating a slurry-like cathode composite material on one side or both sides of a current collector. If necessary, a pressure treatment for adjusting the density of the cathode layer may be performed. The thickness of the cathode layer is not particularly limited, and can be selected from, for example, a range of 10 μm to 100 μm.

### Battery Forming Step

A method of manufacturing a non-aqueous secondary battery of the present disclosure includes a step of forming a battery including a cathode, a anode, and a non-aqueous electrolyte. The step of forming the battery is a step of assembling a structure constituting the secondary battery. As the method, a conventionally known method can be employed. The cathode, the anode, or the non-aqueous electrolyte solution are as described in the above-mentioned <non-aqueous secondary battery>. For example, a structure of a secondary battery is formed by disposing a cathode manufactured by a process of manufacturing a cathode in a battery case (exterior container) so as to face a anode via a separator, injecting a non-aqueous electrolyte solution, and sealing the cathode.

### Salt Decomposing Step

A method of manufacturing a non-aqueous secondary battery of the present disclosure includes a step of forming a battery including a cathode, a anode, and a non-aqueous electrolyte solution, and then decomposing a salt (sacrificial salt) by applying a voltage to the battery. A method of applying a voltage to the battery includes preliminary charging. In the precharge, a voltage capable of decomposing the sacrificial salt may be applied depending on the type of sacrificial salt to be used. For example, as described above, when the sacrificial salt is magnesium oxide, since the theoretical decomposition potential is 2.9 V vs. Li/Li⁺ of magnesium oxide, it is preferable to perform the precharge by applying a voltage exceeding the theoretical decomposition potential.

In the non-aqueous secondary battery and the method for manufacturing the non-aqueous secondary battery of the present disclosure, as described above, calcium ions or magnesium ions and ascorbic acid released by decomposition of the sacrificial salt by the sacrificial salt and ascorbic acid contained in the cathode are preferentially oxidized to dehydroascorbic acid. As a result, it is possible to suppress the formation of an extra coating film while improving the energy density. In this case, since calcium ions or magnesium ions remain in the electrolytic solution at a relatively high concentration, the energy density can be improved satisfactorily.

Further, in the cathode, the sacrificial salt decomposes to form an appropriate void, so that the ion diffusibility can be improved and the rapid charging performance can be improved.

Hereinafter, the present disclosure will be described in more detail with reference to Examples, but the present disclosure is not limited to these Examples.

### Examples 1 to 3 and Comparative Examples 1 to 3

### Manufacture of Batteries

Battery cells for charge and discharge tests were fabricated by the following configuration.
Cell type: Small 1 counter laminated cell
Opposite portion area (cathode): 21 cm²
Cathode active material: NCM (LiNi_{1/3}CO_{1/3}Mn_{1/3}O₂)
Cathode current collector: aluminum foil
Anode active material: metallic Li
Anode current collector: copper foil
Non-aqueous electrolyte: 1.1 M, LiPF₆/EC:DMC:EMC (EC/DMC/EMC volume fraction is 3/4/3)
Separator: polypropylene separator

The cathode was manufactured as follows. The cathode active material (88 parts by mass), acetylene black as a conductive material (10 parts by mass) and polyvinylidene fluoride as a binder (2 parts by mass), sacrificial salt shown in Table 1 (1.8 to 4.7% by mass), ascorbic acid shown in Table 1 (4% by mass) are mixed. Then, the viscosity was adjusted with a solvent to obtain a cathode composite material. The cathode composite material was coated on an aluminum foil and dried at 80° C. for 5 minutes to obtain a cathode. The ratio of addition of the sacrificial salt and ascorbic acid shown in Table 1 is a ratio based on the entire cathode composite material.

### Evaluation of Batteries

The obtained cathode, the separator, and the anode containing a metallic Li as an active material were stacked in this order to prepare a battery cell. Then, the prepared battery cells were contained in a laminate film and filled with an electrolytic solution, to thereby prepare the small 1 counter laminate cell type evaluation batteries of Examples 1 to 3 and Comparative Examples 1 to 3. The evaluation battery of Comparative Example 1 is an evaluation battery in which a sacrificial salt and ascorbic acid are not added to the cathode composite material, and the evaluation batteries of Comparative Examples 2 to 3 are evaluation batteries in which ascorbic acid is not added to the cathode composite material.

### Measurement Method

The following measurements were performed, and the measurement results are described in each column of Table 1. In the columns of “Type of sacrificial salt” and “addition of ascorbic acid” in Table 1, what is described as “none” indicates that the respective addition was not performed.

In Table 1, the value of “sacrificial ion concentration in the electrolytic solution after charging” is a value measured by the method described above. The “effective volume energy density of the cathode” is a theoretical value of the volume energy density calculated by considering the types of the cathode active material and the anode active material, the voids after the sacrificial salt decomposition, and the volume of the cathode active material added to the cathode composite material in excess for forming a SEI. The “amount of gas generated during storage at 60° C. for 1 week” is a value obtained by placing a battery for evaluation in a sealed bag, holding the battery for evaluation for 1 week in a thermostat controlled so as to be in an environment of 60° C., and then measuring the amount of gas generated from the battery for evaluation by the Archimedes method. In the “1 C capacitance/0.1 C capacitance ratio”, the ratio of the latter 1 C capacitance to the former 0.1 C capacitance was determined when charging to 4.25 V was performed with 0.1 C current value by the constant current-constant voltage method and then discharging to 3.0 V was performed with 1 C current value by the constant current method.

TABLE 1

| | | | Mixing | | | | |
|---|---|---|---|---|---|---|---|
| | | | ratio of | | | | |
| | | | the | | | Volume | |
| | | | sacrificial | Concentration | Effective | of gas | |
| | | Addition | salt in the | of sacrificial | volume | generated | |
| | | of | cathode | salt-derived | energy | during | 1 C |
| | | ascorbic | composite | ions in the | density | storage at | capacitance/ |
| | Type of | acid | material | electrolyte | of the | 60° C. for | 0.1 C |
| | sacrificial | (% by | (% by | after charging | cathode | one week | capacitance |
| | salt | mass) | mass) | (mol/L) | (Ah/L) | (cc) | Ratio (%) |
| Example 1 | MgO | 4 | 1.8 | 0.16 | 775 | 0.8 | 46 |
| Example 2 | CaO | 4 | 2.6 | 0.16 | 766 | 0.9 | 48 |
| Example 3 | MgCO₃ | 4 | 3.9 | 0.16 | 748 | 1.5 | 52 |
| Comparative | None | None | 0 | 0 | 714 | 2.2 | 35 |
| Example 1 | | | | | | | |
| Comparative | Li₂C₂O4 | None | 4.7 | 0.32 | 718 | 4.5 | 54 |
| Example 2 | | | | | | | |
| Comparative | MgO | None | 1.8 | 0.32 | 780 | 3.2 | 45 |
| Example 3 | | | | | | | |

### Evaluation Results

As shown in Comparative Example 1, when ascorbic acid and sacrificial salt were added as shown in Examples 1 to 3, the energy efficiency and the rapid charging performance of the cathode were improved while suppressing the generation of gas as compared with the case where sacrificial salt and ascorbic acid were not added. This is evident from Table 1. On the other hand, as in Comparative Example 2 and Comparative Example 3, even when the sacrificial salt was contained, the amount of gas generated increased when the sacrificial salt was not contained.

As described above, the electrolytic solution contains calcium ions or magnesium ions at a level equal to or higher than 0.1 mol/L based on the entire non-aqueous electrolyte, and the cathode composite material contains ascorbic acid. As a result, the energy density of the cathode was improved and the generation of gas was suppressed.

What is claimed is:

1. A non-aqueous secondary battery, comprising: a cathode;
an anode; and
a non-aqueous electrolyte, wherein
the non-aqueous electrolyte contains at least one of calcium ions and magnesium ions at a concentration of 0.1 mol/L or higher, with respect to the entire non-aqueous electrolyte, and
the cathode contains dehydroascorbic acid.

2. The non-aqueous secondary battery according to claim 1, wherein:
the non-aqueous electrolyte contains calcium ions; and
reactive potential of anode material included in the anode is 0.26 V vs. Li/Li⁺ or higher.

3. The non-aqueous secondary battery according to claim 1, wherein:
the non-aqueous electrolyte contains magnesium ions; and
reactive potential of anode material included in the anode is 0.74 V vs. Li/Li⁺ or higher.

4. The non-aqueous secondary battery according to claim 1, wherein:
the cathode includes at least one salt selected from a group consisting of magnesium oxide, calcium oxide, and magnesium carbonate, and ascorbic acid;
at least a portion of each of the calcium ions and the magnesium ions is derived from a salt included in the cathode; and
the dehydroascorbic acid is derived from ascorbic acid included in the cathode.

5. A manufacturing method of a non-aqueous secondary battery, the manufacturing method comprising:
producing a cathode using a cathode composite material in which a cathode active material, a salt containing calcium ions or magnesium ions, and ascorbic acid are mixed;
fashioning a battery including the cathode, an anode, and a non-aqueous electrolyte; and
applying a voltage to the battery to decompose the salt, wherein the cathode composite material contains the salt in an amount of 1% by mass or more with respect to the entire cathode composite material.
